(19) United States
(12) Patent Application Publication
(10) Pub. No.: US 2010/0309758 A1
(43) Pub. Date: Dec. 9, 2010

(54) TRACKING SERVO METHOD OF OPTICAL VIDEO DISC PLAYER AND ITS SPECIAL DEVICE

(76) Inventors: Yong Zhang, Liaoning (CN); Youli Guo, Liaoning (CN); Xiuyu Wang, Liaoning (CN); Yingxiong Wu, Liaoning (CN); Liang Song, Liaoning (CN); Zheng Ma, Liaoning (CN)

Correspondence Address: ZHANG, Yong, NO.1 HUA ROAD, HIGH TECHNOLOGY ZONE DALIAN, LIAONING, 116023, CN

(21) Appl. No.: 12/864,508

(22) PCT Filed: Sep. 8, 2008
(86) PCT No.: PCT/CN08/72290

§ 371 Date: Jul. 26, 2010

(51) Int. Cl. G11B 7/00

(52) U.S. Cl. 369/44.11; G9B/7

(57) ABSTRACT

A tracking servo method of an optical video disc player and its special device which accomplish angle adjustment in a simple, time-saving and effort-saving manner and improve the tracking servo capability of the optical video disc player. In the tracking servo method of an optical video disc player, a laser beam is split into a main beam and two sub beams, and tracking error signal generated from the two sub beams are subtracted from tracking error signal generated by the main beam; light spot of the main beam is circular in shape, and light spots of the two sub beams are elliptical in shape. The special device has an effective grating region (1). The effective grating region (1) has a middle zone (2) and two side zones (3, 4); the middle zone (2) has two side edges which are parallel and equal in length, and the two side edges has a distance therebetween which is 10-90% of diameter of the effective grating region (1), and the middle zone (2) and the two side zones (3, 4) have different grating pitches.

### BACKGROUND OF THE INVENTION

The present invention belongs to the field of optical video disc players and more particularly pertains to a tracking servo method of an optical video disc player and its special device that improve the tracking servo capability of optical video disc players.

The tracking servo method of present optical video disc players is basically differential push-pull method (DPP). A laser beam is first split into 3 beams (a main beam and two sub beams) with a grating. The split beams are transmitted through beam splitting prism, objective lens and so forth and then reflected towards the disc track. By means of adjusting the angles between the three beams and the disc track, the signals generated by the light spot of the main beam and the light spots of the two sub beams are opposite to each other in phase. The tracking servo error signal generated by the light spot of the main beam is called MPP. The tracking servo error signal generated by the light spots of the two sub beams is called SPP. For both the MPP and the SPP, the useful AC components overlap with the unnecessary DC components. As the AC components of the MPP and the SPP are opposite in phase, the unnecessary DC components would be offset and the useful AC components would be summed up after subtracting the SPP from the MPP in accordance with the DPP method. When reading an eccentric disc, the DC component of the MPP and the DC component of the SPP would vary. In order to eliminate the variation in the DC components of the tracking servo error signals, the overall tracking servo error signal DPP=MPP−K*SPP, wherein K=variation in the DC component of MPP/variation in the DC component of SPP. In the present tracking servo devices, the effective grating regions have equal grating pitch, and so the light spots of the main beam and the sub beams formed are circular in shape. When the optical disc is tilted or the objective lens is shifted, the angle between the three beams and the disc track would then be changed and therefore result in deviation, and the AC component of the SPP and the AC component of the MPP are the same or similar in phase. After the SPP is subtracted from the MPP, the DPP value becomes basically 0, and the tracking servo could no longer continue tracking, leading to a lower servo capability. The tracking servo capability of a video disc player could only be improved by means of precise optical adjustment, yet such adjustment of the angle is complex, time consuming as well as difficult to operate.

### BRIEF SUMMARY OF THE INVENTION

In order to overcome the problem of poor servo capability in the prior art, the present invention provides a tracking servo method of an optical video disc player and a special device thereof, which accomplish angle adjustment in a simple, time-saving and effort-saving manner and improve the tracking servo capability of the optical video disc player.

The technical solution of the present invention is: a tracking servo method of an optical video disc player, wherein a laser beam is split into a main beam and two sub beams, and tracking error signal generated from the two sub beams are subtracted from tracking error signal generated by the main beam, characterized in that light spot of the main beam is circular in shape, and light spots of the two sub beams are elliptical in shape.

A special device for the tracking servo method of an optical video disc player which has an effective grating region 1, and the effective grating region 1 has a middle zone 2 and two side zones 3, 4; the middle zone 2 has two side edges which are parallel and equal in length, and the two side edges has a distance therebetween which is 10-90% of diameter of the effective grating region 1, and the middle zone 2 and the two side zones 3, 4 have different grating pitches.

The distance between the two side edges of the middle zone 2 is 40-60% of the diameter of the effective grating region 1. The middle zone 2 has a larger grating pitch than the two side zones 3, 4, and the two side zones 3, 4 have equal grating pitch.

The present invention splits a light spot emitted by a laser emitting device into a circular light spot of the main beam and two elliptical light spots of the sub beams. For both the MPP signal generated by the light spot of the main beam and the ESPP tracking error signal generated by the light spots of the two sub beams, the AC signals overlap with the DC signals; however, for the ESPP, the AC signal is small and the DC signal remains unchanged. After subtracting the ESPP from the MPP, the useless DC signals are offset and the useful AC signal is basically the AC signal of the MPP. Therefore, even if deviation occurs due to a change in the angle between the three light beams and the disc track caused by tilting of the disc or shifting of the objective lens, the resulting tracking servo error value EDPP (EDPP=MPP−K*ESPP) is almost unchanged. The tracking servo remains unaffected, thus improving the tracking servo capability of the optical video disc player and ensuring the quality of the product. Also, since the requirement of the angle accuracy is not high, the angle adjustment could be accomplished in a simple, time-saving and effort-saving manner. The device used is simple in structure and easy to manufacture.

### BRIEF DESCRIPTION OF THE DRAWINGS

FIG. 1 is a diagram showing the light spots of the embodiment of the present invention under normal adjustment.

FIG. 2 is a diagram showing the waveform of the MPP of the embodiment of the present invention under normal adjustment.

FIG. 3 is a diagram showing the waveform of the ESPP of the embodiment of the present invention under normal adjustment.

FIG. 4 is a diagram showing the waveform of the EDPP of the embodiment of the present invention under normal adjustment.

FIG. 5 is a diagram showing the light spots of the embodiment of the present invention when deviation occurs during adjustment.

FIG. 6 is a diagram showing the waveform of the MPP of the embodiment of the present invention when deviation occurs during adjustment.

FIG. 7 is a diagram showing the waveform of the ESPP of the embodiment of the present invention when deviation occurs during adjustment.

FIG. 8 is a diagram showing the waveform of the EDPP of the embodiment of the present invention when deviation occurs during adjustment.

FIG. 9 is a diagram showing the structure of the special device of the embodiment of the present invention.

### DETAILED DESCRIPTION OF THE INVENTION

The embodiment of the present invention will be described below with reference to the accompanying figures.

A tracking servo method of an optical video disc player, wherein a laser beam is split into a main beam and two sub beams, and tracking error signal generated from the two sub beams are subtracted from tracking error signal generated by the main beam, characterized in that light spot of the main beam is circular in shape, and light spots of the two sub beams are elliptical in shape.

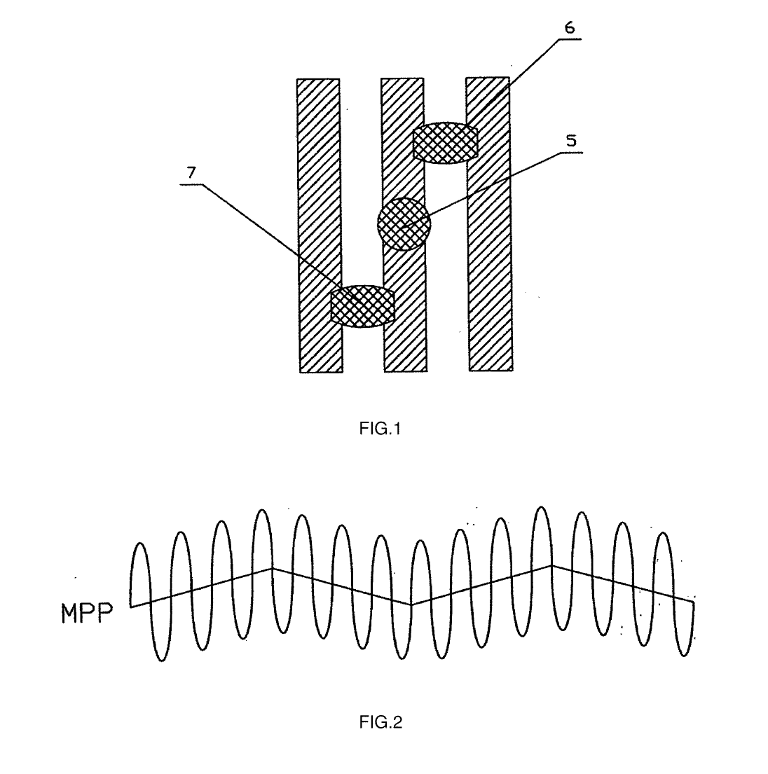

The light spots under normal adjustment are as shown in FIG. 1. Since the light spots of the useful sub beams are elliptical in shape, the vertical and horizontal numerical apertures of the light spots are different when they are incident on the objective lens. According to the definition:

Focal diameter:

$$D = K \frac{λ}{NA}$$

Where:
D—is the diameter of the light spot
K—is a constant
λ—is the wavelength
NA—is the numerical aperture

For an elliptical light spot, the numerical aperture of the light spot along its longer axis is large and so the light converging power is strong, and the diameter of the light spot is small; the numerical aperture of the light spot along its shorter axis is small and so the light converging power is weak, and the diameter of the light spot is large. Therefore, the focus as formed is also elliptical in shape, but with the longer and shorter axis interchanged in direction.

When emitting laser to a disc, the light spot of the main beam 5 and the light spots of the sub beams 6, 7 are projected on the disc track, with the longer axis of the elliptical light spots of the sub beams 6, 7 being perpendicular to the direction of the track.

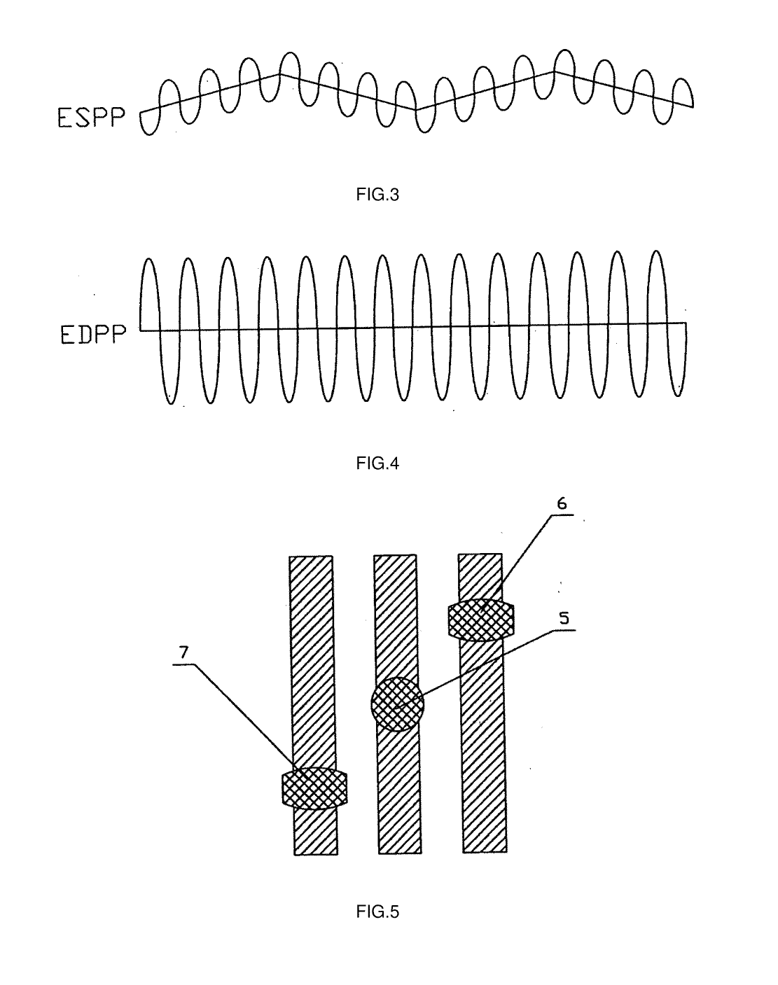

The waveforms of the MPP, ESPP and EDPP generated are shown in FIG. 2, FIG. 3 and FIG. 4 respectively. For both the MPP signal generated by the light spot of the main beam and the ESPP tracking error signal generated by the light spots of the two sub beams, the AC signals overlap with the DC signals; however, for the ESPP, the AC signal is small and the DC signal remains unchanged. After subtracting the ESPP from the MPP, the useless DC signals are offset and the useful AC signal is basically the AC signal of the MPP.

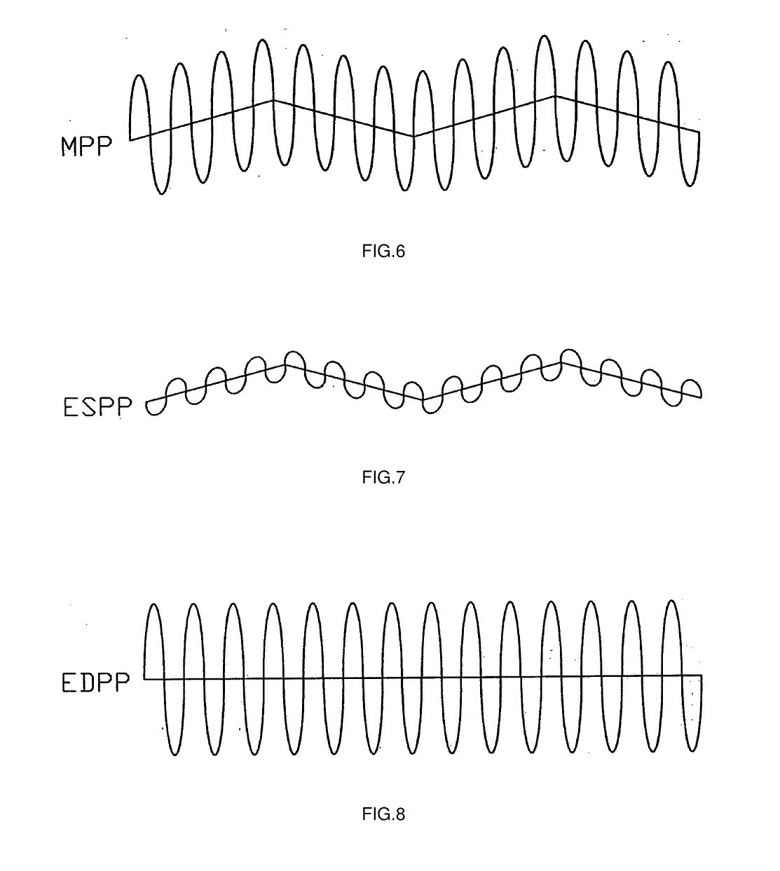

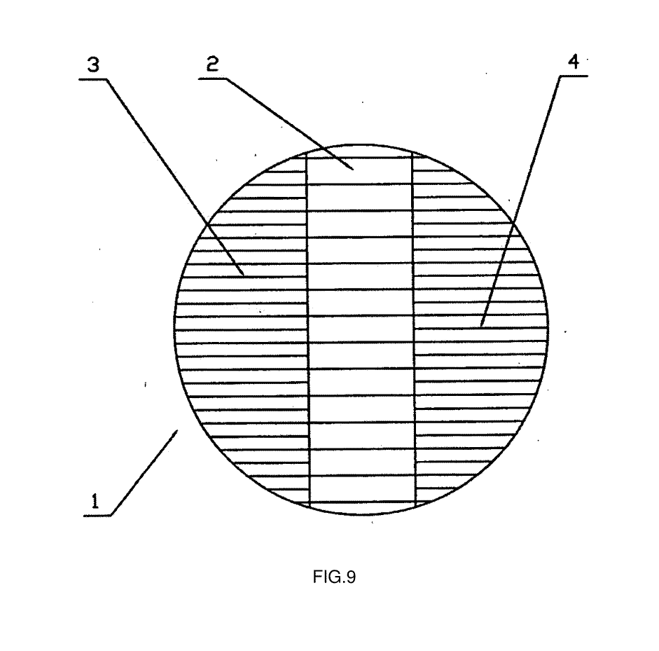

FIG. 5 shows the lights spots when deviation occurs due to a change in the angle between the three light beams and the disc track caused by tilting of the disc or shifting of the objective lens. The waveforms of the MPP, ESPP and EDPP generated are shown in FIG. 6, FIG. 7 and FIG. 8 respectively. There is no change in the DC component and the AC component of the MPP signal generated by the main beam. The AC signal of the tracking servo error signal ESPP generated by the light spots of the sub beams has a small variation in amplitude and the DC signal remains unchanged. Therefore, after subtracting the ESPP from the MPP, the useless DC signals are offset and the useful AC signal is basically the AC signal of the MPP. The tracking servo remains unaffected, thus improving the tracking servo capability of the optical video disc player and ensuring the quality of the product.

The special device of the embodiment of the present invention as illustrated in FIG. 9 is a grating with special structure. It has an effective grating region 1, and the effective grating region 1 has a middle zone 2 and two side zones 3, 4; the middle zone 2 has two side edges which are parallel and equal in length, and the two side edges has a distance therebetween which is 10-90% of diameter of the effective grating region 1, and the middle zone 2 and the two side zones 3, 4 have different grating pitches.

The distance between the two side edges of the middle zone 2 is 40-60% of the diameter of the effective grating region 1. The middle zone 2 has a larger grating pitch than the two side zones 3, 4, and the two side zones 3, 4 have equal grating pitch.

According to the principle of diffraction gratings, a small grating pitch has a large diffraction angle and the sub beams would be diffracted to an area farther away from the main beam; on the other hand, a large grating pitch has a small diffraction angle and the sub beams would be diffracted to an area nearer to the main beam. The grating pitch could be determined based on the distances of the light reception surfaces of the main beam and the sub beams. In the embodiment of the present invention as shown in FIG. 1, the middle zone 2 and the two side zones 3, 4 have different grating pitches. After diffracting from such grating, the light spot of the main beam remains to be circular in shape, but the light spots of the two sub beams as diffracted from the middle zone 2 are elliptical in shape, and the diffracted light spots from the two side zones are not considered since they are not used.

I claim:

1. A tracking servo method of an optical video disc player, wherein a laser beam is split into a main beam and two sub beams, and tracking error signal generated from the two sub beams are subtracted from tracking error signal generated by the main beam, characterized in that light spot of the main beam is circular in shape, and light spots of the two sub beams are elliptical in shape.

2. A special device for the tracking servo method of an optical video disc player as in claim 1 which has an effective grating region (1), characterized in that the effective grating region (1) has a middle zone (2) and two side zones (3), (4); the middle zone (2) has two side edges which are parallel and equal in length, and the two side edges has a distance therebetween which is 10-90% of diameter of the effective grating region (1), and the middle zone (2) and the two side zones (3), (4) have different grating pitches.

3. The special device for the tracking servo method of an optical video disc player as in claim 2, characterized in that the distance between the two side edges of the middle zone (2) is 40-60% of the diameter of the effective grating region (1), and the middle zone (2) has a larger grating pitch than the two side zones (3), (4), and the two side zones (3), (4) have equal grating pitch.
